(19) United States
(12) Patent Application Publication
(10) Pub. No.: US 2002/0091639 A1
(43) Pub. Date: Jul. 11, 2002

(54) Enterprise information and communication management system and method

(75) Inventors: Michael Mandahl, Stockholm (SE); Jan Morath, Hasselby (SE); Christer Gustafsson, Stockholm (SE)

Correspondence Address: OSTROLENK FABER GERB & SOFFEN, 1180 AVENUE OF THE AMERICAS, NEW YORK, NY, 100368403

(73) Assignee: LINQ System svenska AB

(21) Appl. No.: 09/758,783

(22) Filed: Jan. 11, 2001

(51) Int. Cl. H04K 1/00; H04L 9/00; G06F 17/60

(52) U.S. Cl. 705/50

(57) ABSTRACT

A portal interface service provides easily managed information flow which permits simple and direct information retrieval. Users of the portal interface are assigned to membership in groups related to access of specific services and applications. Each portal interface user is also assigned an individual profile that is customizable for individually tailored information flow. Each user is permitted to personalize the display of information received from the portal interface for retrieval of specifically targeted pertinent information. Users need only be authenticated once to obtain access to a potentially large number of systems and applications. System security is provided for each object within the system, in addition to overall security. The system can be accessed by internal, external and mobile users, each of which can received desired information in personalized formats.

### BACKGROUND OF THE INVENTION

1. Field Of the Invention

The present invention relates generally to providing information to individuals or groups within an enterprise or organization on a customizable basis. More specifically, the present invention provides a system and method that permits users to select information useful to their tasks and operations, and to present the selected information in a format of the user's choosing.

2. Description of the Related Prior Art

The present business enterprise and organization environment relies heavily on information disseminated in electronic format. E-mail, voice mail and web page content are just a few well known means for providing users access to needed information related to operations within the enterprise or organization. Groups or individuals within an organization typically desire or need to share information to reach their various goals and accomplish assigned tasks. A variety of software and systems are available to assist individuals and groups in the management of information and information flow between various entities.

One well-known group oriented enterprise software system permits the definition of various user groups associated with groups of individuals within an enterprise that deal with similar information content, or that have a need to share information among the members of the defined group. The software system typically permits the users to send and receive content to various other members within the group, to other individuals or groups within the enterprise or to individuals or groups external to the enterprise. Group users typically have access to an enterprise Intranet for sharing data, and an external Internet for external system access and data sharing. The definition of group membership allows the members access to access information only available to the group, for instance.

This type of group oriented software system generally permits the user to access desired or needed information from various sources, both internal and external to the enterprise. The user typically must submit a request for information, either specifically to an individual or group, or through an information gathering function, such as a search engine.

A feature provided by this type of software system is data base operation related to groups or individuals. For example, a number of individuals or groups can operate on one or more data bases to modify the data base information content. Other users with access to the data base can view changes to the data base information, which can be presented to a given user in various forms. For instance, some users may have read only access, and may view the data base information through a template. Other users may have a need to modify the information within the data base in response to changes made by other individuals or groups. Automated programs may also change the data base information content based on a given set of rules, such as rules containing business logic. Often, these data bases are used on a large scale within the enterprise, and may actually be located at one or more physical locations that are interconnected through a network.

Another type of information distribution in an organization can be obtained through a centralized data source, often referred to as a portal. A typical portal provides information links to various individuals; groups and information sources based on function or task assignments. The portal will also usually provide tools, such as search engines, for the user to locate desired or needed information. The information content provided by a portal can typically be specifically oriented to a particular individual or group to improve information access ease and efficiency.

In each of the above described systems, the individual user or group of users are unable to customize the type and form of information desired or needed by the individual or group. While a user may be offered several selections from which to choose based on job description and function to obtain the most pertinent information, the user is unable to choose the specific information and form in which it is presented. In addition, features such as wireless or remote access are often difficult to implement in these systems because of limitations in technology and security access procedures.

Another aspect of managing information within an organization or enterprise is the need to be able to create and share information efficiently to operate properly. One part of creating and sharing information needed by the organization is providing the right information to the proper or intended party, without creating information overflow. It is often the case that individuals or groups within an organization receive information which is not pertinent to their job function or task at hand. Sorting through or sifting through volumes of information ranging from the completely non-pertinent to the very on point and useful requires a fair amount of time and resources typically dedicated to a project or task as a whole.

When an organization wishes to upgrade or migrate its information handling system to an upgraded or totally new system, often representing a new paradigm in information management, the process typically requires large commitments of resources and time expenditures. For example, an organization will typically rely upon an outside consultant to analyze the organization's systems, recommend a solution and implement specific portions of a solution over a period of time. This process can be lengthy and difficult for the organization in view of the change in operational procedure such a shift represents. In addition, it is often difficult to adjust an implementation model as the organization's business changes over the course of time. For example, key positions may be created, modified or terminated as part of the business operations, which must be incorporated into any solution provided by a solution implementer.

Large organizations typically have a number of departments, each with a unique set of information needs. Often, however, the information needs of some departments overlap in some respects. An increase in productivity and efficiency can typically be obtained in the departments needing similar information can obtain that information from a single source, rather than from several independent sources. It is typically difficult, however, to enable departments to share data from a single source due to a lack of common goals, tasks and cooperation between departments with regard to resources, timing and so forth. As a result, it is often the case that different departments obtain redundant information from a variety of sources and retain the services of several information providers that cannot be easily interconnected, or cannot be used to share data on a departmental or interdepartmental basis.

An information management solution that provides a customized result or service can be used to provide specific information needed by particular individuals or groups. For example, a custom designed website can be developed to extract particular information from a corporate data base and deliver the information to a number of users that require the information in the course of their operations. A customized information management solution such as a web page is often difficult to maintain on an ongoing basis. The customized solution is often not flexible enough to continue to provide the right information as the needs of the particular users change. It is also typically difficult and costly to modify a customized solution to provide needed flexibility.

A number of information management solutions focus on combining the advantages of several commercially available software systems in an integrated package. Such a combination permits many of the information handling facets needed by a typical user, while permitting a measure of flexibility. However, as the various software systems are updated, or new versions are released, they often need to be reintegrated to continue to provide a solution for information management. Integration of new versions of software systems, or the addition of new systems to an integrated set of systems is often very costly and resource intensive.

User authentication is another area that is difficult to handle within a large organization containing many different departments. Typically, due to the different missions and goals of each department, individuals within a department will need access to a variety of different applications, which typically do not overlap in their usefulness within different departments. It is often the case that a user in a given department will have to authenticate themselves to the various applications through multiple logins, each with typically a different password and user name. For departments which have application intensive needs, the authentication process for each application may become repetitive and frustrating. The typical user prefers to logon and authenticate one time only, and often will be reluctant to use a system in which multiple authentications are required.

One widely used technique to overcome the problems of having multiple user authentications is to map all user logons in a secure data base. The user simply indicates a desire to access a particular service, and the stored user ID and password are retrieved from the secure data base, as indicated by the mapping to the user's name, and are used as input for their service authentication. However, this technique requires that the secure data base be updated for each new user, or whenever a new system is implemented. Further administration for the secure data base is required if users must change their passwords or user ID periodically. This requirement places a large administrative burden on the individuals whose task it is to maintain the secure data base. Again, this solution is somewhat resource intensive, and can be cumbersome when a large number of services are used by multiple departments.

### SUMMARY OF THE INVENTION

In view of the above discussion, it is an object of the present invention to overcome the drawbacks present in the state of the art.

Briefly stated, according to the present invention, there is provided a portal interface service that provides easily managed information flow, which permits simple and direct information retrieval. Users of the portal interface are assigned to membership in groups related to access of specific services and applications. Each portal interface user is also assigned an individual profile that is customizable for individually tailored information flow. Each user is permitted to personalize the display of information received from the portal interface for retrieval of specifically targeted pertinent information. Users need only be authenticated once to obtain access to a potentially large number of systems and applications. System security is provided for each object within the system, in addition to overall security. The system can be accessed by internal, external and mobile users, each of which can received desired information in personalized formats.

According to an embodiment of the present invention, there is provided an information portal, comprising: a service access interface connectable to at least one service, a portal directory connected to the service access interface, a user access interface connected to the portal directory, at least one user group, at least one user profile, and the at least one user group and the at least one user profile both being related to the at least one service through a configuration of the service access interface and being related to the user access interface through a configuration of the portal directory.

According to another embodiment of the present invention, there is provided a method of providing organization information, comprising: connecting at least one information source with a user access configuration, configuring the user access configuration to provide access to the at least one information source by at least one user, and providing the at least one user with a customization tool effective to customize presentation of information accessible in the at least one information source by the at least user.

According to another embodiment of the present invention, there is provided a processor operable to execute a program code from a storage memory, the program code comprising: a first code segment executable to connect at least one information source with a user access configuration, a second code segment executable to configure the user access configuration to provide access to the at least one information source by at least one user, and a third code segment executable to provide the at least one user with a customization tool effective to customize presentation of information accessible in the at least one information source by the at least user.

According to another embodiment of the present invention, there is provided a computer readable media containing a program code executable to provide organization information to a user, the program code comprising: a first code segment executable to connect at least one information source with a user access configuration, a second code segment executable to configure the user access configuration to provide access to the at least one information source by at least one user, and a third code segment executable to provide the at least one user with a customization tool effective to customize presentation of information accessible in the at least one information source by the at least user.

According to another embodiment of the present invention there is provided a computer network for deploying an information portal, comprising: a service access interface connectable to at least one service, a portal directory connected to the service access interface, a user access interface connected to the portal directory, at least one user group, at least one user profile, and the at least one user group and the at least one user profile both being related to the at least one service through a configuration of the service access interface and being related to the user access interface through a configuration of the portal directory.

### BRIEF DESCRIPTION OF THE DRAWINGS

The above, and other objects, features and advantages of the present invention, will become apparent from the following description read in conjunction with the accompanying drawings, in which:

FIG. 1 is a connectivity diagram showing various components and their interaction according to the present invention;

FIG. 2 is a diagram of interface levels for data access according to the present invention;

FIGS. 3(a) and (b) are computer programs screen displays according to the present invention;

FIG. 4 is a diagram showing the interrelation of user configuration components according to the present invention;

FIG. 5 is a diagram of user authentication access according to the present invention; and

FIG. 6 is an illustration of different companies sharing services according to the present invention.

### DETAILED DESCRIPTION OF THE PREFERRED EMBODIMENTS

The present invention provides a portal for collective access by members of an organization. The portal permits individuals and groups within the organization to productively interact with information, applications and each other on a variety of levels. Access to the portal is available for individuals and groups located within the organization, external to the organization and on a mobile basis. The portal system is easily applied to existing systems to take advantage of prior resource investments. As systems or applications are upgraded, the portal system can be simply modified and expanded to meet the needs of new applications.

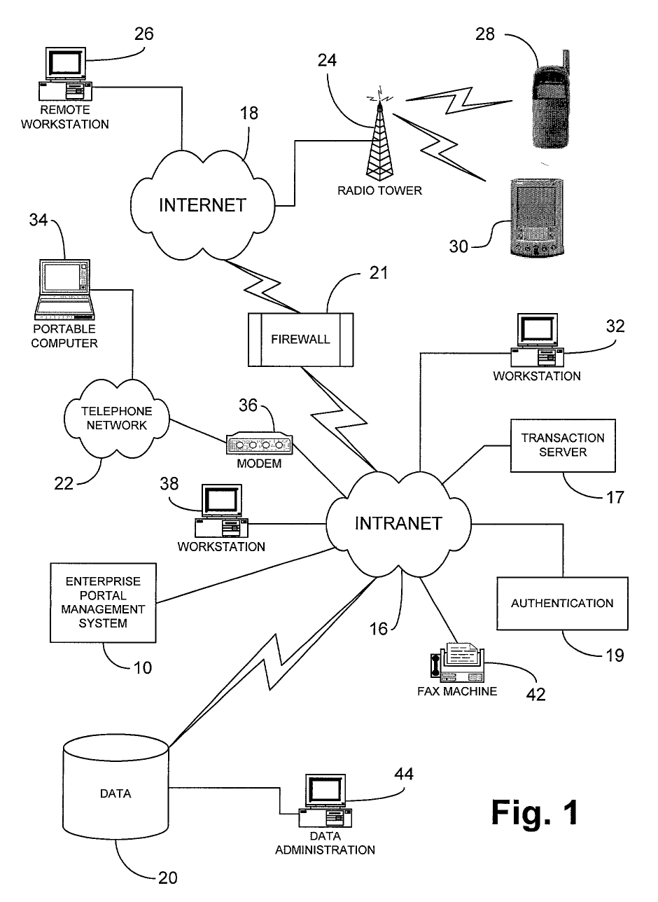

Referring now to FIG. 1, interconnection between various components of a system according to the present invention is shown. Portal system 10 is connected to an organization intranet 16 and provides portal services for users within the organization. Users may be directly connected to organization Intranet 16, using workstations 32 or 38, for example. A user may be connected remotely through a portable computer 34, for example, that is connected to a telephone network 22. Portable computer 34 provides access to organization intranet 16 through a modem 36, which is connected to a telephone network 22. An individual using laptop 34 to connect to intranet 16 can be a remote organization employee, an external user with access privileges or may be associated with a partner organization.

System and user data resides on data base 20, which is administered through a data base workstation 44. Data base 20 holds information related to all aspects of the enterprise operations, such as accounting, personnel, engineering or sales, as typical examples. Data base 20 is not necessarily a single data set, but is rather an abstract of the collection of enterprise information accessible by administrators and users, internally, externally, remotely and on a mobile basis.

Intranet 16 is also connected to an external internet 18 through a firewall 21. All types of users can obtain access to organization intranet 16, including remote individuals or groups associated with the organization, external entities including partner organizations, mobile users, vendors and suppliers. For example, a user associated with the organization may access intranet 16 using a remote workstation 26. In addition, mobile communications can be conducted involving intranet 16 through a radio tower 24 connected to internet 18. Mobile users accessing intranet 16 using a mobile phone 28 or a personal digital assistant (PDA) 30 can also be internal users, external users with permission and so forth. Users can also request faxes from a fax machine 42 connected to intranet 16. A request for a fax transmission can be manual or automatic and can be requested by an individual directly, or through an electronic request.

Operations within intranet 16, such as communications like e-mail or facsimiles, are recorded by a transaction server 17. Each connection to intranet 16 must be authenticated by an authentication service 19. Transaction server 17 and authentication service 19 are relied upon by portal system 10 to provide the framework for portal implementation. For example, portal system 10 includes tools to import authentication data bases from authentication service 19. When authentication data bases are imported, portal system 10 can provide authentication service to the organization users for all registered applications and services. A discussion of service and application registration is provided below.

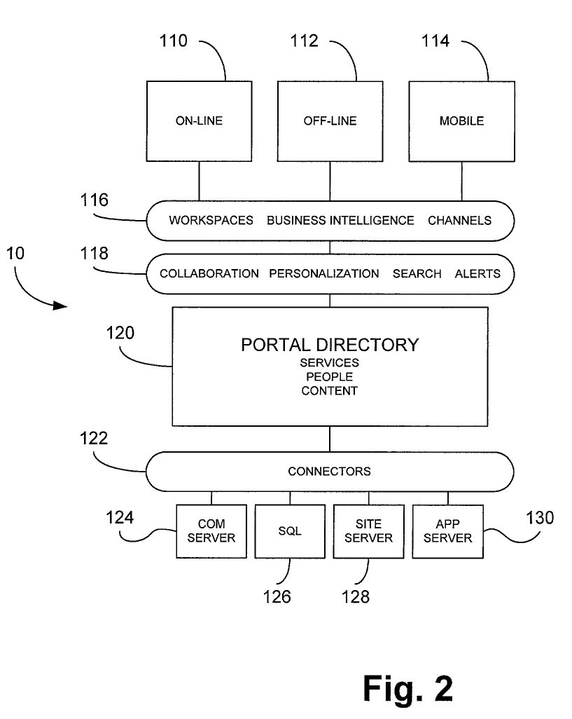

Referring now to FIG. 2, a hierarchical service and connection and diagram of portal management system 10 is shown. User connections to portal system 10 can be made in an on-line connection 110, and off-line connection 112 or a mobile connection 114. Each of the user connections interacts with an information interface 116, which exposes information interfaces for user access. The information interfaces provide the user with various information specific to the user, including workspaces common to other users or groups, business intelligence related to the organization and information channels that provide more general type information such as news, weather, etc.

Information interface 116 provides the user with a customized display of custom selected information, selectable from all of the services and applications for which the user has permissions. Applications and services available for user access include group and organization centered activities, as indicated by a portal system layer with an application interface 118. A user can select from among the various applications and services offered in application interface 118 to personalize information interface 116. For example, if a user belongs to a particular group within the organization, particular group activity information can be selected by the user for display through information interface 116. Some examples of other features available through application interface 118 include collaboration, personalization, searching and various types of alerts.

The engine behind operation of portal system 10 is indicated in FIG. 2 as a portal directory 120. Portal directory 120 provides the facilities for application and service access, individual user personalization, user authentication, information flow, group membership and access; and user profile information, among others. Portal directory 120 can accommodate any number of applications and services through the use of component object models (COM) and registration within portal directory 120. COM constructs provide standardized interfaces for access to complex applications and services. Registration of an application or service in portal system 10 provides a reserved allocation of resources and a known connection.

Portal directory 120 interacts with various standard applications, services and data base engines through a connector layer 122. Connector layer 122 contains a number of interface translators or engines that provide a conduit between portal directory 120 and other services and applications. For example, a Uniform Resource Locator (URL) may be registered as a service or application with portal directory 120 for access by a particular set of individuals or groups. The URL may be tied to an application or service that is used to varying degrees by the individuals or groups to which it is allocated. For example, one user may require access to a certain aspect of a given service represented by a URL, while a group or department may wish to utilize a number of detailed aspects of the application or service.

Among the tools used by portal directory 120 to provide portal services are various servers and engines which also help to administer aspects of portal system 10. A communication server 124 provides communication services including messaging, contact data bases, network support and various other communication oriented services.

A data base engine 126 that uses a Standard Query Language (SQL) provides access to various data stores for data manipulation and retrieval. SQL operations within data base engine 126 provide access to stored data for applications and portal services including administrative information, content and personalized information. User group membership and user profiles, in addition to user directory information are all stored on SQL type data bases accessible through data base engine 126.

A site server 128 provides services for searching and navigation through the various portal directories and interfaces. Site server 128 accesses information related to user group membership and user profiles to permit personalized searches while providing proper insulation and security between and among all users.

An application server 130 provides application and services resources to various individuals and groups through portal directory 120. For example, mobile connection 114 may require special software and applications for mobile related services that differ from those required by on-line connection 110 to view or manipulate the same information. The application and software that permits mobile connection user 114 to manipulate information also accessible to on-line connection 110 can be stored on application server 130.

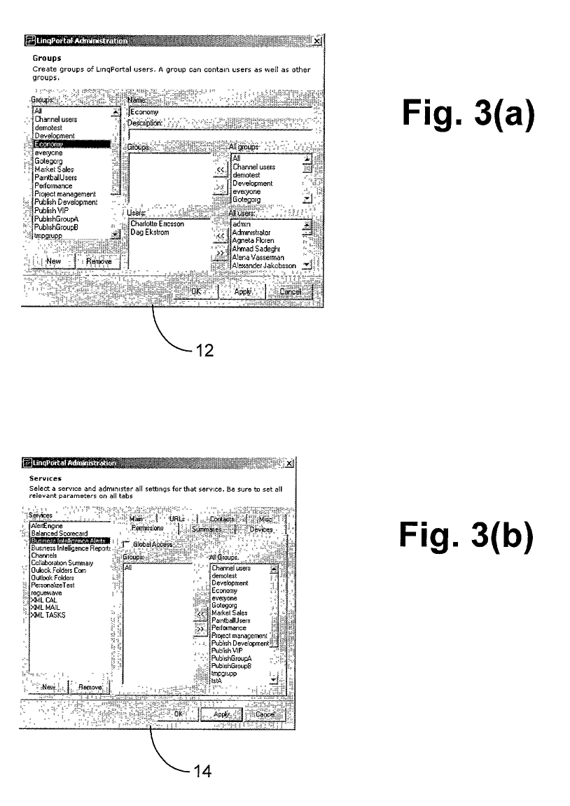

Referring now to FIGS. 3(a) and (b), there is shown a group administration screen 12 and a services administration screen 14. Group administration screen 12 permits access to and manipulation of groups and group membership. Groups may be created, removed, or modified with regard to membership. Group administration screen 12 permits all users to be assigned to a given group, for instance. Conversely, group administration screen 12 also permits certain users to be assigned to all groups. Assigning certain users to all groups permits efficient and simple administration. For example, an administrator may be assigned to all groups to permit access to all services assigned to the various groups.

Service administration screen 14 permits administration of applications and services provided to portal directory 120. Services can include applications, URLs of websites, business intelligence, contacts and so forth. As with administration of user groups, the various services can be assigned to one or more groups for simple administration.

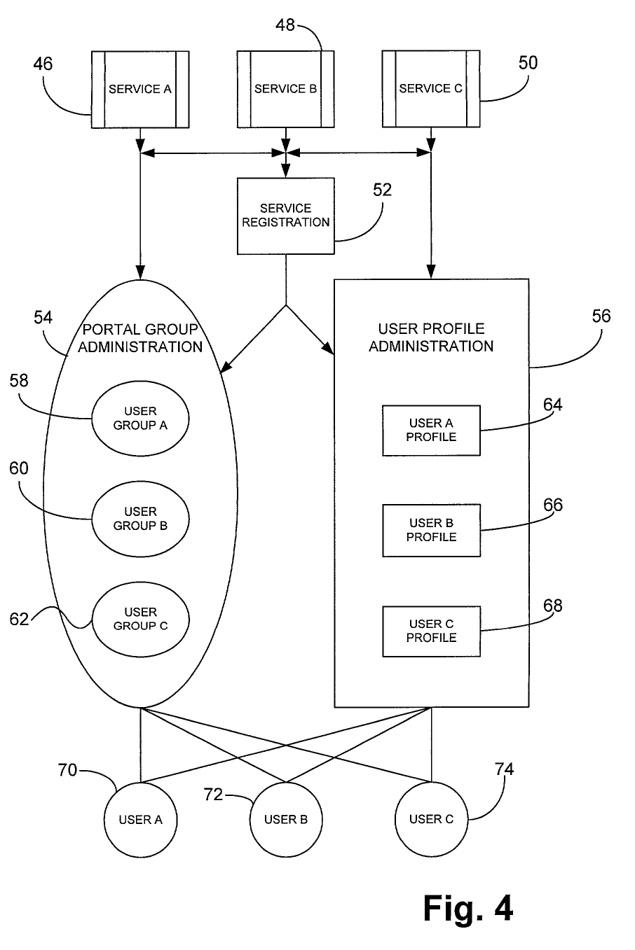

Referring now to FIG. 4, a schematic diagram shows the various interconnections between services and users. A number of services are shown in the abstract as a service 46, a service 48 and a service 50. Each of services 46, 48 and 50 are registered with a service registration 52. Service registration 52 provides portal system 10 with information about services 46, 48 and 50 to permit access by various users. Services 46, 48 and 50 will be used variously by users 70, 72 and 74. For example, user 70 may need access to all of services 46, 48 and 50, while user 72 may only need to access a portion of service provided by service 46. Each of users 70, 72 and 74 are assigned to various groups within a portal group administration 54. For example, all the users 70, 72 and 74 could be assigned to a user group 58. In addition, user 74 may be the only individual assigned to a user group 62, while users 72 and 74 may be assigned to a user group 60. By assignment to the various groups, the users will have access to services provided to that particular group. For example, all of the members of user group 58 may have access to service 46, 48 and 50. User group 58 obtains access to services 46, 48 and 50 through registration of the services with service registration 52.

Each user account has assigned to it a user profile through a user profile administration 56. User profile administration 56 contains a profile for each individual user. A profile for each user defines the services and applications to which the user is permitted access. User profiles also provide customization to the particular user, and reflects the user's personalization of the portal services. As shown in FIG. 4, a user profile 64 is assigned to user 70. A user profile 66 is assigned to user 72, while a user profile 68 is assigned to user 74. A user obtains access to a given application or service by being included in a user group that has access to the particular application or service. The type of access to the application or service, and how it is displayed for a particular user is the defined by that user's profile. For example, user 70 may be a member of user group 58, which has access to service 46, 48 and 50. User 70, however, may only need to obtain a small portion of the information provided by service 46, for instance. Accordingly, user 70 can restrict the amount of information provided by service 46 through settings in user profile 64. User profile 64 may also be employed by user 70 to set up a display of data commonly available to all users in all groups.

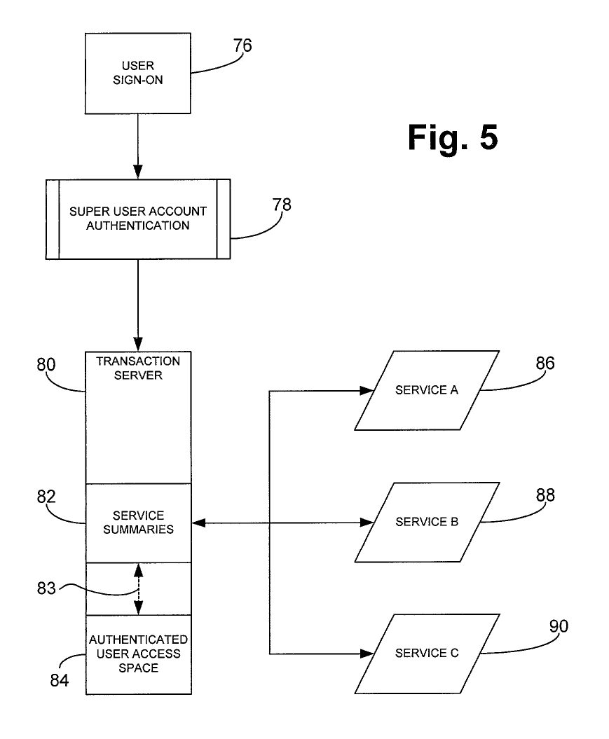

Referring now to FIG. 5, a diagram of authentication flow and service access is shown. When a user first signs in to the portal services, they do so through a user sign-on 76. During user sign-on 76, the user will enter an ID and a password that identifies the user to the system. The user ID and password are sent to a super user authentication 78 for verification of the user and registration with all other authentication services. By being successfully authenticated through super user authentication 78, the user is provided access to all authenticating services and applications, in the format which the user has selected in the user profile. A successful super user authentication is passed to a transaction server 80, which has access to all the various applications and services desired by the user. Transaction server 80 previously accesses and queries services 86, 88 and 90 shown in FIG. 5 to obtain a service summary 82 according to the information settings and the user profile. Once the user becomes authenticated and has access to transaction server 80, service summary 82 is presented to an authenticated user access space 84. The authenticated user may then review the service summary provided to the user as a result of membership in the particular groups associated with services 86, 88 and 90, and the settings in the user profile.

If the user requires further information than is provided by service summary 82, the user can then be specifically authenticated for access directly to the desired service. For example, if the user wishes to directly access service 86, the user request is passed through transaction server 80 to super user authentication 78. Super user authentication 78 contains a mapping of the user ID and password to all other application and service authentications. Once the user request is received by super user authentication 78, the appropriate authentication for service 86 is retrieved and applied by transaction server 80 to grant the user full, direct access to service 86.

This arrangement permits the user to sign on once in user sign-on 76, and gain access to all needed information, and be authenticated to various services and applications when the need for a direct access arises. Access to the various services by the user through authenticated user access space 84 is obtained by determining the proper group and user profile permissions, illustrated as a link 83. Once properly configured, the authentication system automatically provides tailored information to the user, ready for retrieval upon user access and authentication.

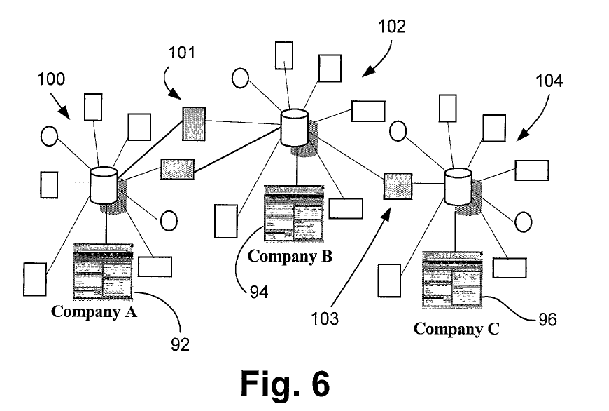

Referring now to FIG. 6, a configuration of portal service 10 spread among various company entities is shown. In this configuration, companies 92, 94 and 96 are connected to each other through a portal service interface, which permits the companies to share information and resources. For example, if company 94 is a vendor to company 92, and product information for company 94 is stored on an organization network 102, individuals within company 92, having access to an organization network 100 can receive product information from company 94 over organization network 102 through a network connection 101. Network connection 101 provides an interface between company 92 and 94 for the sharing of information and resources, which can be presented using the portal services available to company 92 and 94. In addition, a company 96 may be a manufacturer having an organization network 104 that can provide information to company 94 through network connection 103. Accordingly, company 94 and 96 can share information related to manufacture of products or components for company 94. For example, company 94 can register a purchase order through their portal service which is delivered through organization network 102 across network connection 103 to organization network 104 of company 96. An individual or group at company 96 can review the purchase request from company 94 using their portal service access, and can schedule manufacturing production accordingly. The individuals or groups at company 96 can also respond with specific information to company 94 across network connection 103, such as delivery time and pricing.

One aspect of this feature of intercompany connection is the availability of push and pull services. For example, if company 92 ships a product from inventory, and the shipping is made known to network 100, an automatic request can be sent to company 94, for example, through organization network 102 across network connection 101 to order more inventory. Conversely, if company 96 has developed a new service or product, that information or resource can be automatically sent through organization network 104 to organization network 102 of company 94 across network connection 103 to automatically update information or resources at company 94. The use of portal services by each of the interconnected companies permits concise and productivity related data to be sent to and received by the appropriate individuals to more efficiently and productively realize their goals and task. Because the portal services used by each of company 92, 94 and 96 can be personalized, and can be determined by inclusion in group membership, a number of efficiencies and realized and put into practical use.

Referring again to FIG. 2, integration of new applications and services with portal system 10 can be accomplished in a straightforward manner using COM constructs. For example, communication server 124, database engine 126, site server 128 and application server 130 each provides an interface for connection through COM constructs. When a service or application is introduced or upgraded, the COM interface need only be defined and registered with service registration 52 (FIG. 4). Once a service is registered, it is available for display and selection on services administration screen 14 (FIG. 3(b)). The service or application can then be assigned to various user groups, service summaries 82 (FIG. 5) can be defined, and any other needed settings can be provided.

With this arrangement, services or applications can be administered with ease and efficiency. If a service or application requires authentication, the user ID and password is stored in portal system 10 under the authentication mapping for the appropriate users. Upon accessing the system, users are provided with personalized service summaries 82, as determined by the user profile settings. As discussed above, further direct service access is accomplished simply and easily by accessing the user service authentication and applying it to the service interface.

Administration of authentication mappings is simplified by providing service summaries 82 (FIG. 5) because the typical user needs only information provided in summary format. The number of users requiring direct access to the service is thus greatly reduced, along with attendant administration burdens.

Although the present invention has been described in relation to particular embodiments thereof, other variations and modifications and other uses will become apparent to those skilled in the art. Accordingly, the present invention is not to be limited to the specific disclosure herein, but only the appended claims.

What is claimed is:

1. An information portal, comprising:
a service access interface connectable to at least one service;
a portal directory connected to said service access interface;
a user access interface connected to said portal directory;
at least one user group;
at least one user profile; and
said at least one user group and said at least one user profile both being related to said at least one service through a configuration of said service access interface and being related to said user access interface through a configuration of said portal directory.

2. An information portal according to claim 1, wherein said at least one user profile is assignable to a user.

3. An information portal according to claim 2, wherein said at least one user profile is configurable by at least one of said user and an administrator.

4. An information portal according to claim 3, wherein said at least one user profile configuration can specify a portion of said at least one service available to said at least one user.

5. An information portal according to claim 1, further comprising a user authentication engine effective to provide security access to said portal directory and said at least one service.

6. An information portal according to claim 5, wherein said authentication engine is operable to maintain an authentication mapping, whereby said at least one user is granted security access to said at least one service by securely accessing said portal directory through said authentication engine.

7. An information portal according to claim 1, further comprising:
an information summary related to said at least one service;
said information summary being updateable when an information content of said at least one service is updated;
an indication of an activity in said information portal; and
said information content being updateable based on said indication.

8. An information portal according to claim 1, wherein said service access interface is a standardized interface effective to connect to a plurality of services in a standardized format.

9. An information portal according to claim 5, further comprising:
a migration tool operable to transfer authentication information from an information system to said portal directory; and
said transferred authentication information being usable by said user authentication engine effective to provides said security access.

10. A method of providing organization information, comprising:
connecting at least one information source with a user access configuration;
configuring said user access configuration to provide access to said at least one information source by at least one user; and
providing said at least one user with a customization tool effective to customize presentation of information accessible in said at least one information source by said at least user.

11. A method of providing organization information according to claim 10, wherein said connecting is performed with a standardized interface with said information source.

12. A method of providing organization information according to claim 11, wherein:
said user access configuration includes at least one user group associated with said information source;
said user access configuration further includes at least one user profile associated with said at least one user;
said at least one user is a member of said at least one user group; and
said at least one user can operate said customization tool to manipulate settings in said at least one user profile to effect said customized presentation.

13. A method of providing organization information according to claim 10, further comprising:
operating a user authentication engine to access said at least one information source; and
providing said at least one user with access to an information summary related to an information content of said information source.

14. A method of providing organization information according to claim 13, wherein said at least one user can directly access said information source through operation of said authentication engine.

15. A method of providing organization information according to claim 13, further comprising:
updating said information summary when related information in said information content is updated; and
permitting said at least one user to set an alert when said information summary is updated.

16. A method of providing organization information according to claim 13, further comprising:
identifying an activity by said at least one user related to said information content; and
updating said information content based on said activity.

17. A method of providing organization information according to claim 13, further comprising:
updating said information summary when related information in said information content is updated;
identifying an activity by said at least one user related to said information content; and
updating said information content based on said activity.

18. A processor operable to execute a program code from a storage memory, said program code comprising:
a first code segment executable to connect at least one information source with a user access configuration;
a second code segment executable to configure said user access configuration to provide access to said at least one information source by at least one user; and
a third code segment executable to provide said at least one user with a customization tool effective to customize presentation of information accessible in said at least one information source by said at least user.

19. A computer readable media containing a program code executable to provide organization information to a user, said program code comprising:
a first code segment executable to connect at least one information source with a user access configuration;
a second code segment executable to configure said user access configuration to provide access to said at least one information source by at least one user; and
a third code segment executable to provide said at least one user with a customization tool effective to customize presentation of information accessible in said at least one information source by said at least user.

20. A computer network for deploying an information portal, comprising:
a service access interface connectable to at least one service;
a portal directory connected to said service access interface;
a user access interface connected to said portal directory;
at least one user group;
at least one user profile; and
said at least one user group and said at least one user profile both being related to said at least one service through a configuration of said service access interface and being related to said user access interface through a configuration of said portal directory.
